(19) United States
(12) Patent Application Publication
(10) Pub. No.: US 2025/0304860 A1
(43) Pub. Date: Oct. 2, 2025

(54) WATER/CRUDE OIL EMULSION REMOVERS BASED ON AMPHIPHILIC TERPOLYMERS WITH RANDOM ALKYL ACRYLIC-VINYL-AMINOALKYL ACRYLIC SEQUENCES

(71) Applicant: Instituto Mexicano del Petróleo, Mexico City (MX)

(72) Inventors: Flavio Salvador Vázquez Moreno, Mexico City (MX); César Andrés Flores Sandoval, Mexico City (MX); Patricia Pérez Romo, Mexico City (MX); Gerardo Zavala Olivares, Mexico City (MX); Esteban López Salinas, Mexico City (MX); Gerardo Nicolás Rodríguez Araujo, Mexico City (MX); Citlally Janinne Vargas Martínez, Mexico City (MX); Geanine Lisbeth Manobanda Navas, Mexico City (MX); Metzli Corona Estrada, Mexico City (MX); Carlos David Rodríguez Araujo, Mexico City (MX); Héctor Alejandro Aranda Hernández, Mexico City (MX); Enrique Cevada Maya, Mexico City (MX)

(21) Appl. No.: 19/097,494

(22) Filed: Apr. 1, 2025

(30) Foreign Application Priority Data
Apr. 2, 2024 (MX) MX/A/2024/004088

(51) Int. Cl. C10G 33/04; C08F 20/18

(52) U.S. Cl. CPC C10G 33/04; C08F 20/18

(57) ABSTRACT

The present disclosure relates to the development of new dehydrating agents capable of efficiently removing emulsified water present in crude oils, using alkyl acrylic-vinyl-aminoalkyl acrylic-based terpolymers of different monomeric compositions and molecular weights. These new terpolymers are synthesized using an emulsion polymerization technique in a semi-continuous reactor (under monomer starved feed conditions), to ensure that the terpolymers present randomness in their chain sequences, as well as a low chains polydispersity. Due to their chemical nature, these terpolymers resist acid stimulation operations in wells, do not induce asphaltene precipitation and do not adhere to rocks in well applications.

### CROSS-REFERENCE TO RELATED APPLICATIONS

This patent application claims priority under 35 U.S.C. Section 119 to Mexican Patent Application No. MX/a/2024/004088, filed Apr. 2, 2024, the entire disclosure of which is incorporated herein by reference.

### FIELD

The present disclosure belongs to the field of petroleum conditioning chemicals, particularly demulsifiers. This disclosure concerns the application of amphiphilic terpolymers with random alkyl acrylic-vinyl-aminoalkyl acrylic sequences to remove emulsified water—emulsions of W/O or O/W/O type, at micro- and nano-emulsion dimensions—and the salts, dissolved in the latter, present in crude oils with gravities between 1° and 40° API (with different water content and SARA compositions-saturated, aromatic, resin and asphaltene compounds-)—; specifically, for its application in petroleum wells (to avoid damage to the formation caused by emulsions)—, in offshore devices—(three-phase separators) and in land devices (prior to the refining process).

### BACKGROUND

Currently, the largest proportion of petroleum extracted from crude oil reserves worldwide consists of heavy and extra-heavy crude oils [1], containing significant amounts of water and salts [2]. Simple water-in-crude oil (W/O) emulsions or complex crude oil-in-water-in-crude oil (O/W/O) emulsions are formed because of intense stirring upon crude oil extraction and transportation processes, as well as due to water injection into wells to keep adequate production pressure and extraction speed. These emulsions are extremely stable and difficult to remove due to the high amount of natural surfactants present in crude oil, mainly asphaltenes and/or resins, along with other surfactants that surround the dispersed water droplets in the crude oil, increasing the rigidity of the interfacial film and thus, creating a highly stable system that hinders or completely prevents water droplet coalescence [3].

In the crude oil transportation process, emulsions and salts—dissolved in the emulsified water and dispersed in the crude oil—cause an increase in the viscosity of the crude oil, leading to significant technical difficulties during the pumping process of a highly viscous fluid, which also results in economic problems. Additionally, corrosion and fouling of pipelines and equipment used to transport crude oil occur, as well as the poisoning of catalysts in the crude oil refining process [4].

On the other hand, it is important to mention that the maximum allowed water content in crude oil is from 0.2 to 0.5 vol %, which has led to the implementation of various methods to dehydrate crude oil and to achieve this maximum water content. These methods include electrostatic, thermal, mechanical, ultrasonic, biological, microwave radiation, and chemical treatments, each one used individually or in combination. The chemical treatment method, based on the application of demulsifying agents capable of destabilizing the water/crude oil interface, is the most frequently used in the oil industry due to its low cost compared to other methods, and its high performance in removing emulsified water [5-8].

A wide variety of demulsifying agents have been reported in the literature; however, for industrial applications, triblock bipolymers of poly(ethylene oxide)-poly(propylene oxide)-poly(ethylene oxide) (PEO-PPO-PEO) are the most widely used due to their efficiency in removing emulsified water. It is important to mention that a single basic component, PEO-PPO-PEO, does not possess all three required properties of a demulsifying agent: breaker, coalescer, and water clarifier. Therefore, it is necessary to formulate and combine at least three basic components with different average molecular weights (M̅ₙ) and propylene oxide/ethylene oxide (PPO/PEO) weight ratios to ensure the final formulation contains all three properties. It is crucial to note that the performance of a PEO-PPO-PEO-based formulation is hindered by acidic well stimulation operations due to the chemical degradation of terminal hydroxyl groups (—OH) caused by abrupt pH changes [9]. Another drawback of these PEO-PPO-PEO triblock bipolymers is their synthesis process, which involves two stages—the first one to form the polypropylene oxide (PPO) block and the second one to form the polyethylene oxide (PEO) blocks, both of which are carried out under high pressure and temperature [10]. Therefore, if a formulation consists of three PEO-PPO-PEO basics, six stages are necessary for this formulation. Finally, there is currently a low availability of ethylene oxide in the global market, leading to higher costs for the final product.

These drawbacks of PEO-PPO-PEO triblock bipolymer-based formulations also apply to compositions based on ethoxylated phenolic resins and/or ethoxylated nonylphenols. Therefore, it is of utmost importance to have demulsifying agents with a chemistry different from that of polyethers. In this regard, acrylic-based compounds have shown to be an excellent option to replace these currently used technologies. Concerning the use of such products, U.S. Patent document U.S. Pat. No. 4,968,449 reports the use of alkoxylated vinyl bipolymers for the qualitative removal of emulsified water in crude oils using an arbitrary scale [11].

Patent documents MX 386485 [12], U.S. Pat. No. 10,975,185 [13], and CA 2,987,447 C [14] report on the use of random mass-controlled bipolymers using alkyl acrylate and aminoalkyl acrylate to control the formation of water-in-crude oil (W/O) emulsions and to remove water and salts (dissolved in the aqueous phase) present in crude oils, having densities ranging from 10 to 40° API. These innovative dehydrating agents demonstrated superior performance in removing emulsified water compared with that of the FDH-01 commercial formulation, which is composed of four basics consisting of POE-POP-POE triblock bipolymers with different molecular weights.

On the other hand, Mexican patent application document MX/a/2018/00297 [15], U.S. patent document U.S. Pat. No. 10,793,783 [16] and Canadian patent document CA 3,013,494 C [17] protect the production of alkyl acrylate and carboxyalkyl acrylate-based bipolymers with controlled molecular weight and varying monomeric compositions by weight—always maintaining a higher proportion of the base alkyl acrylate (A)—as well as their use as demulsifying agents for crude oils with gravities ranging from 5 to 40° API. The 80/20 wt. % alkyl acrylate/carboxyalkyl acrylate weight monomer ratio showed the highest efficiency as a demulsifying agent, removing 100% of the emulsified water at a dosage of 1500 ppm in a 6.11° API crude oil after 120 minutes of evaluation. It is important to mention that the alkyl acrylate/carboxyalkyl acrylate weight monomer ratio has a significant impact on the performance of the bipolymer as a demulsifying agent. In this case, the 80/20 wt. % A/F acrylic bipolymer exhibited excellent performance in removing emulsified water in a 7.55° API crude oil at a dosage of 250 ppm, eliminating the emulsified water after 300 minutes of evaluation. When the weight ratio was changed to 70/30, the performance decreased to 85 vol %, with a more noticeable effect when the ratio was lowered to 60/40, where only 50 vol % of the emulsified water was removed. In all evaluated crude oils, the 80/20 A/F acrylic bipolymer outperformed the FDH-1 commercial formulation polyether-based).

Regarding the use of acrylic-based terpolymers for crude oil dehydration, Vargas' undergraduate thesis (in Spanish) [18] titled “Synthesis and Evaluation of Random Acrylic Terpolymers for the Dehydration of Extra-Heavy Crude Oils” refers to the use of random acrylic terpolymers for the removal of emulsified water in crude oils of different API gravities. However, the thesis does not specify the chemical structures of the monomers used to obtain these dehydrating agents, making it impossible to infer them.

Mexican patent application documents MX/a/2020/002212 [19] and U.S. patent application US20210277314 [20] protect the use of alkyl acrylate-aminoalkyl-carboxyalkyl-based terpolymers with random structural sequences as demulsifying agents for crude oils with gravities ranging from 3 to 40° API. In this case, random acrylic terpolymers with 90/05/05, 80/10/10, and 60/10/30 wt. % monomer ratios and average molecular weights ranging from 11,839 to 16,418 g·mol⁻¹ showed higher efficiency in removing emulsified water than the TOMAC (tri-n-octyl methyl ammonium chloride) ionic liquid and the FDH-1 commercial formulation (based on PEO-PPO-PEO triblock bipolymers).

Likewise, Mexican patent application document MX/a/2020/010501 [21] and U.S. patent application US20220106530 [22] protect the use of random alkyl acrylate-aminoalkyl-alkoxyalkyl-based terpolymers as demulsifying agents for crude oils with gravities ranging from 8 to 40° API. These random acrylic terpolymers demonstrated superior water removal capabilities compared to the FD-1 commercial formulation polyether-based f and the universal demulsifier F-46 TRETALITE™ (used in land and offshore evaluations). The random acrylic terpolymers that showed the best performance as dehydrators and clarifiers corresponded to monomeric compositions of 60/30/10 and 70/20/10 wt. %, with average molecular weights (M̅ₙ) of 17,445 and 15,273 g/mol, respectively.

Patent application MX/a/2022/008218 [23] specifies new random alkyl acrylate-carboxyalkyl acrylate-alkoxyalkyl acrylate-based terpolymers, where their production process and use as dehydrating agents for crude oils, with gravities ranging from 10 to 40° API, are protected. The random acrylic terpolymers BuCE-6131, BuCE-7211, BuCE-7121, BuCE-8111, and BuCE-9551, dosed at 500 ppm, completely removed the emulsified water present in the crude oil, significantly outperforming the FD-01 commercial formulation and the F-46 universal product. It is important to mention that the BuCE-8111 terpolymer exhibited the highest coalescence rate, achieving maximum removal efficiency after 120 minutes of evaluation. In the optical micrograph of the crude oil treated with this random acrylic terpolymer, no presence of emulsified water droplets was observed at the micro and nano levels. In contrast, the crude oil samples treated with the FD-01 commercial formulation and the F-46 universal demulsifier showed the presence of water droplets with diameters ranging from 0.1 to 1.1 μm (polydisperse system). Finally, the clarifying capacity is noticeably superior to that presented by the FD-1 and F-46 commercial products.

The amphiphilic terpolymers with random sequences of alkyl acrylic-vinyl-aminoalkyl acrylic, with destabilizing properties for water-in-crude oil (W/O) emulsions, which are protected in the present disclosure, were synthesized through the emulsion polymerization process in a semi-continuous process, under monomer-deficient conditions. To produce these alkyl acrylic-vinyl-aminoalkyl acrylic terpolymers, the procedure developed at the Mexican Petroleum Institute was used as a basis, as described in the patent documents MX 338861 B [24], U.S. Pat. No. 9,120,885 [25], MX 378417 [26], MX 383630 [27], U.S. Pat. No. 10,213,708 [28], U.S. Pat. No. 10,221,349 [29], and U.S. Pat. No. 10,982,031 [30]. It is important to note that the random distribution of the alkyl acrylic-vinyl-aminoalkyl acrylic terpolymers, which are protected in the present disclosure, is guaranteed by the dosing of the reactants under monomer-deficient conditions. Due to their chemical structure, the amphiphilic terpolymers, covered by the present disclosure, are highly resistant under acidic conditions, which are encountered during typical acid stimulation operations in crude oil wells to increase the production of the rock formation. This chemical stability allows the amphiphilic terpolymer to keep on functioning along and after the acid stimulation process, resulting in a constant production of the oil well. Therefore, the utilization of amphiphilic terpolymers having alkyl-acryl-vinyl-aminoalkyl acrylic random sequences has technical (use of on single basic component, improved performance and high chemical stability) and economic advantages (use of one single basic component and one single stage process synthesis) in comparison with actual commercial formulations based on polyethers.

### REFERENCES

Citations of the references discussed herein are provided below:
[1] Djuve J., Yang X., Fjellanger I. J., Sjöblom J., Pelizzetti E., Chemical destabilization of crude oil-based emulsions and asphaltene stabilized emulsions, Colloid. Polym. Sci. 2001, 279 (3), 232-239.
[2] Raya S. A., Mohd Saaid I., Abbas Ahmed A., Abubakar Umar A., A critical review of development and demulsification mechanisms of crude oil emulsion in the petroleum industry, J. Pet. Explor. Prod. Technol. 2020, 10 (4), 1711-1728.
[3] Kokal S. L., Crude oil emulsions: a state-of-the-art review, SPE Prod. Facil. 20 (2005) 5-13.
[4] Zolfaghari R., Fakhru'l-Razi A., Abdullah L. C., Elnashaie S. S. E. H., Pendashteh A., Demulsification techniques of water-in-oil and oil-in-water emulsions in petroleum industry, Sep. Purif. Technol. 2016, 170, 377-407.
[5] D. Santos D., Da Rocha E. C. L., Santos R. L. M., Cancelas A. J., Franceschi E., Santos A. F., Fortuny M., Dariva C., Demulsification of water-in-crude oil emulsions using single mode and multimode microwave irradiation, Sep. Purif. Technol. 2017, 189, 347-356.
[6] Abubakar Umar A., Mohd Saaid I. B., Adebayo Sulaimon A., Mohd Pilus R. V., A review of petroleum emulsions and recent progress on water-in-crude oil emulsions stabilized by natural surfactants and solids, J. Pet. Sci. Eng. 2018, 165, 673-690.
[7] Zargar G., Gheysari R. G., Takassi M. A., Rostami A., Zadehnazari A., Evaluation of a sulfanilic acid-based surfactant in crude oil demulsification: an experimental study, Oil Gas Sci. Technol.-Rev. IFP Energies Nouvelles 2018, 73.
[8] Mahmood A., Idris M., Abdul-Ghani M., De la Rosa N., Carvero A., Yrac R., An experimental study on the application of ultrasonic technology for demulsifying crude oil and water emulsions, J. Pet. Environ. Biotechnol. 2017, 8 1-12.
[9] Ojinnaka C. M., Ajienka J. A., Abayeh O. J., Osuji L. C., Duru R. U., Formulation of best-fit hydrophile/lipophile balance-dielectric permittivity demulsifiers for treatment of crude oil emulsions, Egypt. J. Pet. 2016, 25, 565-574.
[10] Zhang, Z.; Xu, G. Y.; Wang, F.; Dong, S. L.; Li, Y. M. Characterization and demulsification of poly(ethylene oxide)-block-poly(propylene oxide)-block-poly(ethylene oxide) copolymers. J. Colloid Interface Sci. 2004, 277(2), 464-470.
[11] Stephenson, W. K. Alkoxylated vinyl polymer demulsifiers. U.S. Pat. No. 4,968,449. Nov. 6, 1990.
[12] Hernández Carbajal, E. I.; López Ortega, A., Flores Sandoval, C. A., Álvarez Ramírez, F., Vázquez Moreno, F. S., Zavala Olivares, G., Clavel López, J. C., y García Jiménez, R. J. Desemulsionantes para aceites crudos con base en copolímeros aleatorios acrílico-aminoacrílico de masa molecular controlada. (In Spanish) Mexican patent: MX 386485. Sep. 15, 2021.
[13] Hernandez Carbajal, E. I., Flores Sandoval, C. A., Álvarez Ramírez, F., López Ortega, A., García Jiménez, R. J., Zavala Olivares, G., Clavel López, J. C., y Vázquez Moreno, F. S. Demulsifiers for crude oil based on acrylic-aminoacrylic random copolymers of controlled molecular mass. U.S. Pat. No. 10,975,185. Apr. 13, 2021.
[14] Hernandez Carbajal, E. I., Flores Sandoval, C. A., Álvarez Ramírez, F., López Ortega, A., García Jiménez, R. J., Zavala Olivares, G., Clavel López, J. C., y Vázquez Moreno, F. S. Demulsifiers for crude oil based on acrylic-aminoacrylic random copolymers of controlled molecular mass. Canadian patent: CA 2 987 447 C. Aug. 10, 2021.
[15] Lopez Ortega, A., Flores Sandoval, C. A., Zamora Guerrero, E. B., Álvarez Ramírez, F. Vázquez Moreno, F. S., Zavala Olivares, G., Chávez Mora, M. A. Removedores de emulsiones agua/aceite crudo con base en copolímeros aleatorios alquilacrílico-carboxialquilacrílico de masa molecular controlada. (In Spanish) Mexican patent submitted: MX/a/2018/002971. Mar. 9, 2018.
[16] Flores Sandoval, C. A., Chávez-Mora, M. A., Zamora Guerrero, E. B., López Ortega, A., Zavala Olivares, G., Álvarez Ramírez, F., Vázquez-Moreno, F. S. Water/crude oil removers based on alkylacrylic-carboxyalkylacrylic random copolymers of controlled molecular mass. U.S. Pat. No. 10,793,783 B2. Oct. 6, 2020.
[17] Flores Sandoval, C. A., Chávez-Mora, M. A., Zamora Guerrero, E. B., López Ortega, A., Zavala Olivares, G., Álvarez Ramírez, F., Vázquez-Moreno, F. S. Water/crude oil removers based on alkylacrylic-carboxyalkylacrylic random copolymers of controlled molecular mass. Canadian patent: CA 3 013 494 C. Dec. 8, 2020.
[18] Vargas, C. J. Chemical engineering thesis (in Spanish), Universidad Veracruzana (UV). Facultad de Ciencias Químicas. Síntesis y evaluación de terpolímeros acrílicos aleatorios para el deshidratado de aceites crudos extra-pesados. Pages 39-43. January 2018.
[19] Vargas Martinez, C. J., Flores Sandoval, C. A., Zamora Guerrero, E. B., Álvarez Ramírez, F., Vázquez Moreno, F. S., Zavala Olivares, G., y Fuentes Santiago, J. V. Desemulsionantes para aceite crudo con base en terpolímeros aleatorios alquilacrílico-aminoacrílico-carboxiacrílico de masa molecular controlada. (In Spanish) Mexican patent submitted: Mx/a/2020/002212. Sep. 20, 2021.
[20] C. A. Flores-Sandoval, F. S. Vázquez-Moreno, F. Álvarez-Ramírez, G. Zavala-Olivares, J. V. Fuentes-Santiago, E. B. Zamora-Guerrero, C. J. Vargas-Martínez. Demulsifying agents for crude oil based on random alkylacrylic-aminoalkylacrylic-carboxyalkylacrylic terpolymers of controlled molecular mass. US patent submitted: US20210277314 A1. Sep. 9, 2021.
[21] Vargas Martínez, C. J., Zamora Guerrero, E. B., Flores Sandoval, C. A., Vázquez Moreno, F. S., Álvarez Ramírez, F., Zavala Olivares, G., Fuentes Santiago, J. V., Cevada Maya, E., Gómez Buendía, E. Nuevas macromoléculas alquiladas, aminadas y alcoxiladas con propiedades trifuncionales integradas para la remoción de emulsiones de petróleo. (In Spanish) Mexican patent submitted: Mx/a/2020/010501. Oct. 5, 2020.
[22] C. A. Flores-Sandoval, F. S. Vázquez-Moreno, F. Álvarez-Ramírez, G. Zavala-Olivares, C. J.-Vargas Martínez, J. V. Fuentes-Santiago, E. B. Zamora-Guerrero, E. Cevada-Maya, E. Gómez-Buendía. Novel alkylated, aminated and alkoxylated macromolecules with integrated trifunctional properties for the removal of petroleum emulsions. US patent submitted: US20220106530 A1. Apr. 7, 2022.
[23] Terpolímeros acrílicos aleatorios de masa molecular controlada empleados como desestabilizadores de agua en aceite crudo. (In Spanish) Submitted Mexican patent: Mx/a/2022/008218. Jun. 30, 2022.
[24] Castro Sotelo, L. V., Flores Oropeza, E. A., Cendejas Santana, G., Lozada y Cassou, M., Vázquez Moreno, F. S. Formulations of random polymers for improving crude petroleum flow. U.S. Pat. No. 9,120,885. Sep. 1, 2015.
[25] Hernández Carbajal, E. I., López Ortega, A., Flores Sandoval, C. A., Álvarez Ramírez, F., Clavel López, J. C., Vázquez Moreno, F. S., Cevada Maya, E. Formulation of terpolymers based on alkyl acrylates employed as antifoaming of gasified heavy and super-heavy crude oils. U.S. Pat. No. 10,982,031. Apr. 20, 2021.
[26] Cevada Maya, E., Castro Sotelo, L. V., Hernández-Carbajal, E. I., Flores-Sandoval, C. A., López-Ortega, A., Estrada-Buendía, A., Álvarez-Ramírez, F., Estrada-Martínez, A., Vázquez-Moreno, F. S. Formulaciones de homopolímeros base acrilatos de alquilo empleadas como antiespumantes en aceites crudos pesados y súper pesados. Mexican patent MX 378417. Dec. 14, 2020.
[27] Hernández Carbajal, E. I., Cevada Maya, E., López Ortea, A., Flores Sandoval, C. A., Álvarez Ramírez, F., Estrada Martínez, A., Vázquez-Moreno, F. S. Formulaciones de copolímeros base acrilatos de alquilo empleados como antiespumantes en aceites crudos pesados y superpesados. Mexican patent MX 383630. Jun. 8, 2021.
[28] E. Cevada-Maya, L. V. Castro-Sotelo, E. I. Hernandez-Carbajal, C. A. Flores-Sandoval, A. López-Ortega, A. Estrada-Buendía, F. Álvarez-Ramírez, A. Estrada-Martínez, F. S. Vázquez-Moreno. Formulations of homopolymers based on alkyl acrylates as antifoaming agents in heavy and super-heavy crude oils. U.S. Pat. No. 10,213,708. Feb. 26, 2019.
[29] E. I. Hernández-Carbajal, E. Cevada-Maya, A. López-Ortea, C. A. Flores-Sandoval, F. Álvarez-Ramírez, A. Estrada-Martínez, F. S. Vázquez-Moreno. Formulations of copolymers based on alkyl acrylates used as defoamers of heavy and super-heavy crude oil. U.S. Pat. No. 10,221,349 B2. Mar. 5, 2019.
[30] E. I. Hernandez-Carbajal, A. López-Ortega, C. A. Flores-Sandoval, F. Álvarez-Ramírez, J. C. Clavel-López, F. S. Vázquez-Moreno, E. Cevada-Maya. Formulation of terpolymers based on alkyl acrylates employed as antifoaming of gasified heavy and super-heavy crude oils. U.S. Pat. No. 10,982,031 B2. Apr. 20, 2021.

### BRIEF DESCRIPTION OF THE DRAWINGS

FIG. 1 reports on the dehydrating efficiencies of the KVI amphiphilic terpolymers, the TOMAC ionic liquid and the FD-01, FD-02, FD-03 and FD-4 commercial formulations, all evaluated in the Lacanhá-1 crude oil (35.30° API) at 80° C. and 1000 ppm.

FIG. 2 exhibits the optical micrographs and bottles with the Lacanhá-1 crude oil (35.30° API) after being treated with the KVI-6314 (100 vol %, 120 min), KVI-7214 (100 vol %, 180 min), KVI-6224 (100 vol %, 240 min), and KVI-6134 (100 vol %, 300 min) amphiphilic terpolymers, as well as with the FD-2 (67 vol %, 300 min) and FD-3 (53 vol %, 120 min) commercial formulations, and finally, with the TOMAC ionic liquid (40 vol %, 60 min).

FIG. 3 shows the dehydrating efficiencies of the KVI amphiphilic terpolymers, the TOMAC ionic liquid and the FD-01, FD-02, FD-03 and FD-4 commercial formulations evaluated in the Lacanhá-2 crude oil (15.20° API, Ø_{H}_{₂}_{O}=30 vol %) at 80° C. and 1000 ppm.

FIG. 4 displays the optical micrographs and bottles with the Lacanhá-2 crude oil (15.20-° API, Ø_{H}_{₂}_{O}=30 vol %) after being treated with the KVI-6314 (100 vol %, 180 min) and KVI-7214 (100 vol %, 240 min) amphiphilic terpolymers, the TOMAC ionic liquid (53 vol %, 300 min) and the FD-1 (53 vol %, 240 min) and FD-3 (53 vol %, 300 min) commercial formulations.

FIG. 5 presents the dehydrating efficiencies of the KVI amphiphilic terpolymers, the TOMAC ionic liquid, as well as the FD-01, FD-02, FD-03 and FD-4 commercial formulations, all evaluated in the Lacanhá-3 crude oil (15.60° API, Ø_{H}_{₂}_{O}=40 vol %) at 80° C. and 1000 ppm.

FIG. 6 features the optical micrographs and bottles with the Lacanhá-3 crude oil (15.60° API, Ø_{H}_{₂}_{O}=40 vol %) after being treated with the KVI-6314 (100 vol %, 120 min) and KVI-6224 (95 vol %, 120 min) random acrylic terpolymers, the TOMAC ionic liquid (84 vol %, 300 min) and the FD-3 (55 vol %, 300 min) and FD-4 (55 vol %, 300 min) commercial formulations.

FIG. 7 shows the dehydrating efficiencies of the KVI-6314 and KVI-7214 amphiphilic terpolymers, as well as those of the FD-1, FD-2 and FD-3 commercial formulations, evaluated in the Lacanhá-4 crude oil (13.80 (° API) at 1000 ppm.

FIG. 8 displays the optical micrographs and bottles with the Lacanhá-4 crude oil (13.80° API) after being treated with the KVI-6314 (86 vol %, 120 min) and KVI-7214 (71 vol %, 60 min) random acrylic terpolymers, as well as with the FD-3 (64 vol %, 60 min), FD-2 (57 vol %, 60 min) and FD-1 (36 vol %, 180 min) commercial formulations.

### DETAILED DESCRIPTION

The present disclosure deals with novel amphiphilic terpolymers with random alkyl acrylic-vinyl-aminoalkyl acrylic sequences and their application as destabilizing agents of water-in-crude oil (W/O) or of crude oil-in-water-in-crude oil (O/W/O) emulsions at micro- and nano-emulsion levels in order to avoid formation damage provoked by emulsions as well as the removal of emulsified water with dissolved salts from offshore units (oil rigs) as well as from onshore separation units for crude oils with gravities ranging from 10 to 40° API (with different water content and composition in the SARA fractions).

The amphiphilic terpolymers with random alkyl acrylic-vinyl-aminoalkyl acrylic sequences are synthesized by an emulsion polymerization technique through a semi-continuous process under strict starved feed conditions, described in detail in the patent documents MX 338861 B [24], U.S. Pat. No. 9,120,885 [25], MX 378417 [26], MX 383630 [27], U.S. Pat. No. 10,213,708 [28], U.S. Pat. No. 10,221,349 [29], and U.S. Pat. No. 10,982,031 [30]. The synthesis requires three monomers: a hydrophobic monomer, which should be present in a high proportion—allowing the terpolymer be soluble in crude oil and can diffuse through it—and two hydrophilic monomers—with different partition coefficients (log P)—at lower proportion. The emulsion polymerization reaction takes place in a reactor at atmospheric pressure. An amount of surfactant, buffer, deionized water and initiator are introduced into the reactor; once the reaction temperature is reached, at the same time, the materials contained in the pre-emulsion tank—consisting of monomers, a surfactant fraction and deionized water—are fed at constant flow. It is worth mentioning that this tank should be under continuous stirring to avoid separation of phases. The main reactor should be kept under constant stirring, nitrogen atmosphere, reflux and constant temperature. The addition of the materials contained in the pre-emulsion tank should be slow to ensure a monomer deficiency condition, thus the mass flow rate is between 1 and 50 g·(L⁻¹·min⁻¹). The reaction temperature should be kept within intervals ranging from 45 to 95° C.; the reaction time will have a total duration from 2 to 12 h. Once the material in the pre-emulsion tank has been consumed, initiator is added to the reactor in amount ranging from 0.1 to 1.0 g, keeping under stirring at controlled temperature for a time ranging from 30 min to 3 h to ensure the total conversion of monomers. As for the employed monomeric ratios, the following proportions are considered: the alkyl acrylate-based monomer is found between 55.00 and 99.40 wt. %, the vinyl monomer from 0.30 to 44.70 wt. % and the aminoalkyl acrylate-based monomer from 0.30 to 44.70 wt. %. Once the reaction is finished, the solvent is evaporated at temperature within the interval ranging from 40 to 130° C. to obtain a viscous liquid. Once the amphiphilic terpolymer is dried, it is dissolved in a suitable organic solvent like: dichloromethane, methanol, ethanol, isopropanol, chloroform, acetone, dimethyl sulfoxide, tetrahydrofuran, dioxane, 2-butoxyethanol, 2-butoxyethanol acetate, benzene and its derivatives, toluene, xylene, jet fuel and naphtha for its final application as dehydrating agent of crude oils with gravities from 10 to 40° API (with different water contents and compositions of the SARA fractions). The effective concentration of the amphiphilic terpolymer is found between 1.00 and 50.00 wt. %, the formulation of the amphiphilic terpolymer is dosed at concentrations from 10 to 3,000 ppm in crude oils with gravities from 10 to 40° API—with different water contents and compositions of the SARA fractions—in order to destabilize the water-in-crude oil (W/O) or crude oil-in-water-in-crude oil (O/W/O) emulsions at micro- and nano-emulsion level present in crude oils and separate the emulsified water.

Formula (1) shows the model structure of the amphiphilic terpolymer with random alkyl acrylic-vinyl-aminoalkyl acrylic sequences reported in this disclosure:

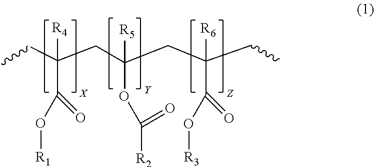

where R₁, R₂, R₃, R₄, R₅ and R₆ are independent of each other, which are represented by the following groups:
R₁═CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₆H₁₁ (di(ethyleneglycol)ethylether), C₈H₁₇ (2-ethylhexyl), C₉H₁₉ (3,5,5-trimethylhexyl), C₈H₁₇ (n-octyl), C₈H₁₇ (iso-octyl), C₈H₉ (ethyleneglycol phenylether), C₁₀H₂₁ (n-decyl), C₁₀H₂₁ (iso-decyl), C₁₀H₁₉ (10-undecenyl), C₁₀H₁₉ (tert-butylcyclohexyl), C₁₂H₂₅ (n-dodecyl), C₁₈H₃₇ (n-octadecyl), C₈H₉O (2-phenoxyethyl), C₃H₇O (2-methoxyethyl), C₅H₁₁O₂ (2-(2-methoxyethoxy)ethyl), C₅H₉O (tetrahydrofurfuryl), C₅H₉O (2-tetrahydropyranyl), C₁₃H₂₇ (n-tridecyl) and C₂₂H₄₅ (behenyl); it is worth emphasizing that the chain of these groups can present different heteroatoms, as well as aromatic rings with or without heteroatoms;
R₂═CH₃ (methyl), Ph (phenyl), C₂H₅ (ethyl), C₅H₇ (pentyl), C₁₁H₂₃, and C₁₇H₃₃;
R₃═CH₄N (methylamine), C₃H₆N (2-ethylamine), C₃H₁₀N (3-propylamine), C₄H₁₀N (2-(dimethylamino)ethyl), C₅H₁₂N (3-(dimethylamino)propyl), C₆H₁₄N (2-(diethylamino)ethyl) or C₆H₁₄NO (N-morpholinyl ethyl); the aliphatic chains can have from 1 to 25 carbon atoms;
R₄ and R₆═H (hydrogen) or CH₃ (methyl);
R₅═H (hydrogen), CH₃ or CN;
x=is a number ranging from 2 to 900;
y=is a number ranging from 2 to 900;
z=is a number ranging from 2 to 900;
likewise, “x”, “y” and “z” can occur in random sequences; the average molecular masses of the amphiphilic terpolymers are found within the interval ranging from 1,000 to 700,000 g/mol.

The following list, as an example, shows the alkyl acrylate monomers selected for the synthesis of the amphiphilic terpolymers that are the subject matter of the present disclosure: methyl acrylate, methyl methacrylate, ethyl acrylate, ethyl methacrylate, n-butyl acrylate, n-butyl methacrylate, iso-butyl acrylate, iso-butyl methacrylate, tert-butyl acrylate, tert-butyl methacrylate, pentyl acrylate, pentyl methacrylate, hexyl acrylate, hexyl methacrylate, di(ethyleneglycol)ethylether acrylate, di(ethyleneglycol)ethylether methacrylate, 2-ethylhexyl acrylate, 2-ethylhexyl methacrylate, (3,5,5-trimethylhexyl) acrylate, (3,5,5-trimethylhexyl) methacrylate, n-octyl acrylate, n-octyl methacrylate, iso-octyl acrylate, iso-octyl methacrylate, (ethyleneglycol phenylether) acrylate, (ethyleneglycol phenylether) methacrylate, n-decyl acrylate, n-decyl methacrylate, iso-decyl acrylate, iso-decyl methacrylate, undecenyl acrylate, undecenyl methacrylate, tert-butylcyclohexyl acrylate, tert-butylcyclohexyl methacrylate, n-dodecyl acrylate, n-dodecyl methacrylate, n-octadecyl acrylate, n-octadecyl methacrylate, 2-phenoxyethyl acrylate, 2-phenoxyethyl methacrylate, 2-(2-methoxyethoxy)ethyl) acrylate, 2-(2-methoxyethoxy)ethyl) methacrylate, tetrahydrofurfuryl acrylate, tetrahydrofurfuryl methacrylate, (2-tetrahydropyranyl) acrylate, (2-tetrahydropyranyl) methacrylate, n-tridecyl acrylate, n-tridecyl methacrylate, behenyl acrylate and behenyl methacrylate.

As for the vinyl monomers selected for the synthesis of the amphiphilic terpolymers that are the subject matter of the present disclosure, the following are found: cyanoethylene acetate, vinyl propionate, vinyl benzoate, vinyl butyrate, vinyl laurate and vinyl stearate, which do not imply any limitation.

Finally, among the aminoalkyl acrylate monomers selected for the synthesis of the amphiphilic terpolymers that are the subject matter of the present disclosure, the following are found: 2-aminoethyl acrylate, 2-aminoethyl methacrylate, 2-(dimethylamino)ethyl acrylate, 2-(dimethylamino)ethyl methacrylate, 3-aminopropyl acrylate, 3-aminopropyl methacrylate, 3-(dimethylamino)propyl acrylate, 3-(dimethylamino)propyl methacrylate, 2-(dimethylamino)ethyl acrylate, 2-(dimethylamino)ethyl methacrylate, 2-N-ethylmorpholine acrylate and N-ethylmorpholine methacrylate.

To describe in detail the amphiphilic terpolymers object of this disclosure, the following demonstrative examples are shown, which should not be considered as limiting. The test terpolymers were characterized by the instrumental techniques listed below:

1. —Size-exclusion chromatography (SEC) employing an Agilent™ 1100 chromatograph with a PLgel-type column, using tetrahydrofuran (THF) as eluent, was employed to calculate the distribution of the polymer molecular masses, as well as the polydispersity index (I). The calibration of the equipment was carried out with polystyrene standards by Polymer Laboratories: RED vial, M̅_{w}=5,000,000; 325,000; 21000 and 1,270 g·mol⁻¹; BLUE vial, M̅_{w}=1,950,000; 113,300; 7,200 and 580 g·mol⁻¹; GREEN vial, M̅_{w}=696,500; 50,400; 2,960 and 162 g·mol⁻¹.

2. —Fourier transform infrared spectroscopy (FT-IR) employing a Thermo Nicolet™ AVATAR 330 spectrometer and the KBr film technique. The data were processed by means of the software OMNIC version 7.0.

3. Nuclear magnetic resonance (NMR) employing a Bruker™ AVANCE NEO 600-MHz spectrometer, with frequencies of 600 MHz and 150 MHz for the 1H and ¹³C spectra, respectively. Deuterated chloroform (CDCl₃) was used as solvent and tetramethylsilane (TMS) as reference. In each case, 150 mg of biopolymer were dissolved in 0.5 mL of deuterated chloroform.

4. Particle diameter (Dz): the particle diameter of polymer latex was obtained employing an Anton Paar Litesizer™ 500 disperser. A solution was prepared with 5 drops of latex in 2.5 mL of distilled water; afterward, the value of the refraction index is determined using an Anton Paar Abbemat™ 300 refractometer, such value is fed to the software Kalliope™ to calculate the value of the particle size.

The amphiphilic terpolymers with random alkyl acrylic-vinyl-aminoalkyl acrylic sequences were synthesized considering weight ratios of the acrylic alkyl/vinyl/acrylic aminoalkyl monomers of 99.40-55.00/44.70-0.30/44.70-0.30 wt. %.

Table 1 shows the average molecular mass and polydispersity index values of the amphiphilic terpolymers with random alkyl acrylic-vinyl-aminoalkyl acrylic sequences; also, the latex particle diameter of poly(alkyl acrylate-vinyl-aminoalkyl acrylate) (R₁=n-butyl, R₂=methyl, R₃=2-(dimethylamino)ethyl) is displayed.

TABLE 1
Compositions (wt. %) of the amphiphilic terpolymers with random alkyl
acrylic-vinyl-aminoalkyl acrylic sequences, average molecular masses
(M̅ₙ) and polydispersity indices (I) of dry terpolymer by SEC,
as well as the latex particle diameter (D_{z}).

| Amphiphilic | Weight | M̅ₙ | Polydispersity | D_{z} |
|---|---|---|---|---|
| terpolymer | ratio (wt. %) | (g · mol⁻¹) | index (I) | (nm) |
| KVI-9554 | 90/05/05 | 6,135 | 2.4 | 200.51 |
| KVI-8114 | 80/10/10 | 4,841 | 2.1 | 206.90 |
| KVI-7214 | 70/20/10 | 5,456 | 2.3 | 208.20 |
| KVI-7124 | 70/10/20 | 5,313 | 2.6 | 207.65 |
| KVI-6314 | 60/30/10 | 9,930 | 1.8 | 209.80 |
| KVI-6224 | 60/20/20 | 3,700 | 2.3 | 198.50 |
| KVI-6134 | 60/10/30 | 4,388 | 1.7 | 203.45 |

### Examples

The following examples are presented to illustrate the spectroscopic characteristics of the amphiphilic random sequence terpolymers of alkyl acrylate-vinyl-aminoalkyl acrylate applied as dehydrating agents in crude oils with gravities ranging from 10 to 40° API-containing different water content and varying SARA fraction compositions. Once the reaction is completed, the solvent is evaporated at a temperature between 4° and 130° C., resulting in a viscous liquid.

### KVI Amphiphilic Terpolymers

I.R. v⁻ (cm⁻¹): 3,442; 2,958; 2,933; 2,875; 1,737; 1,594; 1,511; 1,465; 1,461; 1,396; 1,380; 1,251; 1,164; 1,116; 1,066; 1,024; 998; 960; 943; 840; 740 and 620. ¹H NMR (, CDCl₃) δ (ppm): 0.87, 0.94, 1.26, 1.38, 1.61, 1.9, 1.97, 2.29, 2.34, 2.37, 2.47, 2.57, 2.66, 2.79, 3.07, 3.65, 3.73, 3.38, 4.05, and 4.20. ¹³C NMR (, CDCl₃) δ (ppm): 13.72, 14.07, 19.01, 22.67, 22.95, 28.86, 29.24-29.61, 30.60, 31.73, 31.89, 32.53, 34.72-36.26, 38.56, 41.41, 43.83, 45.18, 56.67, 62.25, 64.45, 70.06, 113.61, 172.75, and 174.51.

Evaluation of Amphiphilic Random Sequence Terpolymers of Alkyl Acrylate-Vinyl-Aminoalkyl Acrylate as Dehydrating Agents for Crude Oils with Gravities Between 1° and 40° API (with Varying Water Content and SARA Fraction Compositions).

To determine the efficiency of emulsified water removal by amphiphilic random sequence terpolymers of alkyl acrylate-vinyl-aminoalkyl acrylate, individual solutions of each dry terpolymer were prepared, considering that the concentration of the KVI amphiphilic terpolymer in the solution ranges between 1.00 and 50.00 wt. %. Solvents such as dichloromethane, methanol, ethanol, isopropanol, 2-butoxyethanol, 2-butoxyethyl acetate, chloroform, benzene and derivatives, toluene, xylene, jet fuel, and naphtha were used either individually or in mixtures to prepare these solutions, ensuring that small volumes of the solution were added, avoiding any influence of the solvent on the removal of water from the evaluated crude oil. The KVI amphiphilic terpolymers were evaluated at concentrations ranging from 10 to 3,000 ppm, along with four widely used commercial formulations in the oil industry—FD-1, FD-2, FD-3, and FD-4—as well as with the TOMAC (tri-n-octylmethylammonium chloride) ionic liquid. The FD-1 commercial formulation is composed of four propylene oxide/ethylene oxide (PO/EO) basics of different molecular masses. Table 2 shows the characteristics of the PO/EO polyethers that make up this formulation. It is essential to mention that polyethers are applied industrially as formulations of at least three PO/EO triblock bipolymer bases, each imparting a function to the formulation, such as breaker, coalescer, and clarifier. The FD-2 commercial formulation is composed of nonylphenol ethoxylates—with different degrees of ethoxylation and different number average molecular masses. The FD-3 commercial formulation is composed of ethoxylated phenolic resin bases—with different degrees of ethoxylation and number average molecular masses. Finally, the FD-4 commercial formulation is an ethylene-formaldehyde oxalkylated arylsulfonate resin, also containing alcohols such as isopropanol and methanol, as well as alkali metal halides —NaCl or KCl—. This formulation is commonly known as F-46 and is widely used in laboratory experiments to determine the total emulsified water content.

TABLE 2
Characteristics of the polyethers comprising the FD-1 commercial
formulation, including their respective number average molecular
mass (M̅ₙ) and PPO/PEO composition in wt. %.
Formulation FD-1

| | M̅ₙ | PPO/PEO composition |
|---|---|---|
| Label | (g · mol⁻¹) | (wt. %) |
| TP 89 | 7,750 | 90/10 |
| TP 03 | 5,330 | 70/30 |
| TP 14 | 3,050 | 60/40 |
| TP 71 | 1,400 | 90/10 |

The procedure used to evaluate the dehydrating efficiencies of the amphiphilic random sequence terpolymers of alkyl acrylate-vinyl-aminoalkyl acrylate of the present disclosure is described as follows: in 150 mL graduated oblong bottles, equipped with inserts and caps, the required aliquot of the KVI random terpolymer solution, as well as the TOMAC ionic liquid and the FD-1, FD-2, FD-3, and FD-4 commercial formulations, are added. One additional bottle, without a demulsifying agent, is considered, adding only the solvent in the specific amount of the aliquot; this bottle is labeled as a control. Subsequently, crude oil is added up to the 100 ml mark; it is essential to emphasize that once the crude oil is dosed, no manual or mechanical agitation of the bottle is performed to homogenize the mixture to avoid alterations to the original emulsion. Moreover, by avoiding shaking the bottle, it is possible to observe the diffusion capacity of the demulsifying agent in the crude oil. Once this process is completed, the first reading of the amount of water removed is taken; subsequently, the bottles are placed in a temperature-controlled thermal bath, ranging from 30 to 90° C. The separated volume of water from the emulsion is measured every 5 minutes during the first hour, then every hour up to a final time of 5 hours.

Table 3 lists the physicochemical characterization of the crude oils used in the evaluation of the amphiphilic random sequence terpolymers of alkyl acrylate-vinyl-aminoalkyl acrylate as dehydrating agents for crude oil with gravities ranging from 10 to 40° API-containing varying water content and SARA fraction compositions.

TABLE 3
Physicochemical characteristics and SARA analysis of crude oils
used for the evaluation of KVI amphiphilic terpolymers.

| Property | Lacanhá-1 | Lacanhá-2 | Lacanhá-3 | Lacanhá-4 |
|---|---|---|---|---|
| Gravity (°API) | 35.30 | 15.24 | 15.60 | 13.80 |
| Salt content (lb/Mbbl) | 3,287 | >151 | >430 | 8,007 |
| Paraffin content | 7.00 | 9.00 | 1.38 | 1.83 |
| (wt. %) | | | | |
| Pour point (° C.) | −27 | −33 | −3 | −27 |
| Water by distillation | 0.10 | 0.50 | 38.00 | 69.00 |
| (vol %) | | | | |
| Water and sediment | 0.10 | 0.50 | 40.00 | 70.00 |
| (vol %) | | | | |
| Kinematic viscosity | 4.70 | 333.50 | 61.52 | 362.0 |
| (mm²/s) @ 25° C. | | | | |
| M̅ₙ by cryoscopy | 224 | 375 | 410 | 447 |
| (g/mol) | | | | |
| Saturates (wt. %) | 38.06 | 51.53 | 26.01 | 33.45 |
| Aromatics (wt. %) | 28.54 | 13.93 | 36.15 | 41.32 |
| Resins (wt. %) | 30.22 | 19.50 | 26.02 | 15.74 |
| Asphaltenes (wt. %) | 3.14 | 15.04 | 11.82 | 8.95 |

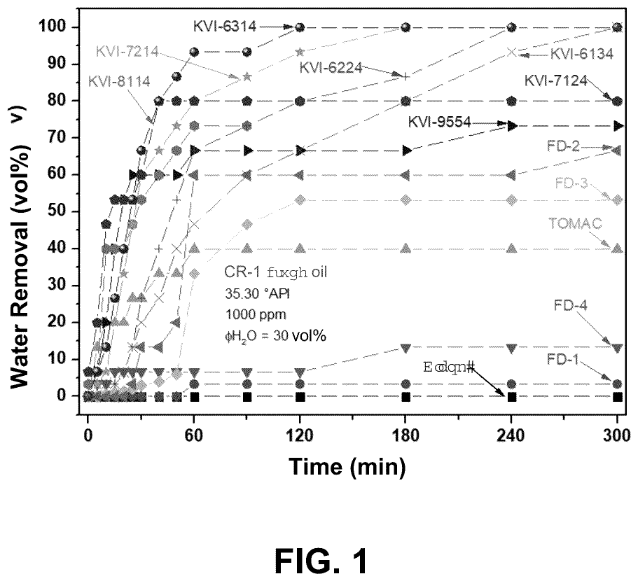

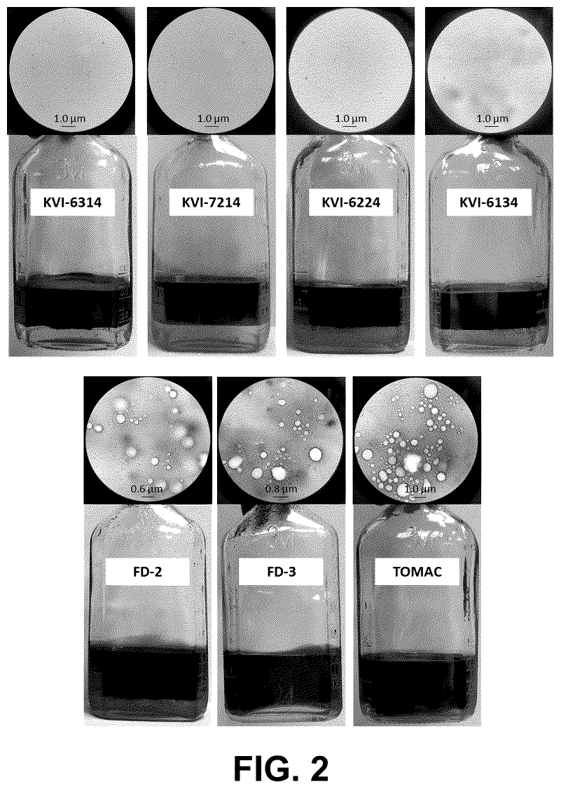

As an example, without any limitation, FIGS. 1, 3, 5, and 7 show the demulsifying efficiencies of the amphiphilic terpolymers with random sequences of alkyl acrylate-vinyl-aminoalkyl acrylate over time. Additionally, FIGS. 2, 4, 6, and 8 display the optical micrographs of the crude oil treated with a specific dehydrating agent—acrylic or polyether-based—as well as the images of the bottles, where the water/crude oil interface and the clarification of the removed water can be observed.

FIG. 1 presents the performance of the amphiphilic KVI terpolymers with random sequences of alkyl acrylate-vinyl-aminoalkyl acrylate in Lacanhá-1 crude oil (35.30° API), dosed at 1000 ppm. As can be seen, the amphiphilic terpolymer KVI-6314 exhibited a slower coalescence rate than other acrylic terpolymers at 25 minutes during the evaluation; however, after this time, there was an increase in the coalescence rate, and it was the first to achieve total removal of the emulsified water, 100 vol %, at 120 minutes into the evaluation. At 180 minutes during the test, the amphiphilic terpolymer KVI-7214 achieved this removal efficiency, followed by KVI-6224 at 240 minutes, and finally, KVI-6134 at 300 minutes of the evaluation. In the case of the KVI-7124 terpolymer, it reached a maximum removal efficiency of 80 vol % at 40 minutes of the test, the same efficiency obtained by the amphiphilic terpolymer KVI-8114, but with a slower coalescence rate, achieving this performance at 120 minutes of evaluation. Finally, the amphiphilic terpolymer KVI-9554 showed the lowest performance in removing emulsified water, reaching an efficiency of 73 vol % at 240 minutes. Regarding the commercial formulations, the best performance was obtained with the formulation FD-2—combination of ethoxylated nonylphenols-, which managed to remove 67 vol % of the emulsified water at 300 minutes into the evaluation. The commercial formulation FD-3—ethoxylated phenolic resin—only removed 53 vol % at 120 minutes, while formulations FD-1—triblock copolymer PPO/PEO—and FD-4—universal demulsifier F-46—barely removed 3 vol % (60 minutes) and 13 vol % (180 minutes), respectively. Regarding the ionic liquid TOMAC, it showed low efficiency in removing emulsified water, reaching a maximum value of 40 vol % at 60 minutes.

FIG. 2 shows the optical micrographs of the crude oil treated with the amphiphilic terpolymers KVI-6314 (100 vol %, 120 min), KVI-7214 (100 vol %, 180 min), KVI-6224 (100 vol %, 240 min), and KVI-6134 (100 vol %, 300 min), where the absence of emulsified water is evident, with only the presence of organic agglomerates being observed. Regarding the micrographs of the commercial formulations FD-2 (67 vol %, 300 min) and FD-3 (53 vol %, 120 min), as well as that of TOMAC (40 vol %, 60 min), the presence of emulsified water in a polydisperse system was observed, with droplet diameters less than 0.1 μm in all three cases, and maximal diameters of 0.6 μm for FD-2, 0.8 μm for FD-3, and 1.0 μm for TOMAC.

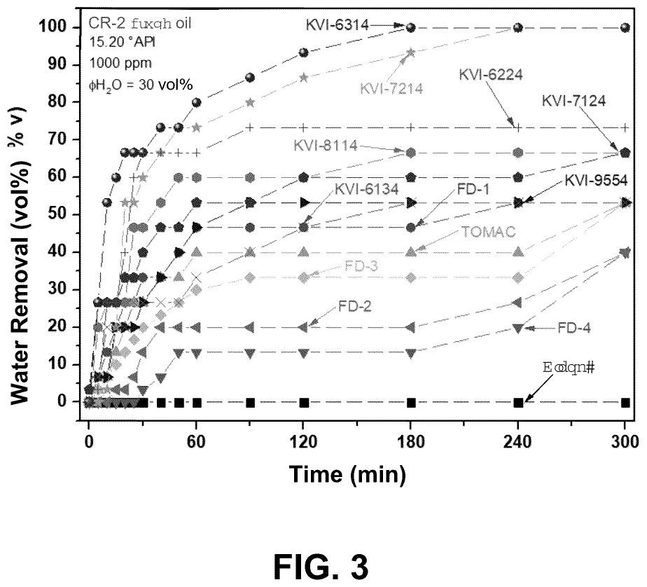

On the other hand, the amphiphilic terpolymers KVI-6314 and KVI-7214 exhibited excellent clarification of the removed water, followed by terpolymers KVI-6224 and KVI-6134, where the clarification was slightly lower than that of the previously mentioned acrylic terpolymers. In comparison, the clarification of the removed water for FD-2, FD-3, and TOMAC was notably much lower than that achieved by the KVI-6224 and KVI-6134 terpolymers. Therefore, it was demonstrated that the KVI amphiphilic terpolymers perform better in the following areas: (1) destabilization of the W/O emulsion, (2) more efficiently inducing the coalescence of the emulsified water droplets, and (3) better performance in clarifying the removed water, significantly surpassing the commercial products and the ionic liquid TOMAC in all three aforementioned areas. FIG. 3 shows the performance of the KVI amphiphilic terpolymers with random sequences of alkyl acrylate-vinyl-aminoalkyl acrylate in Lacanhá-2 crude oil (15.20° API, Ø_{H}_{₂}_{O}=30 vol %), dosed at 1000 ppm. In this heavy crude oil, once again, the KVI-6314 amphiphilic terpolymer showed the best performance in inducing the coalescence of water droplets and achieving total removal of the emulsified water (100 vol %) at 180 minutes into the evaluation. The KVI-7214 amphiphilic terpolymer also reached this water removal efficiency, but 60 minutes later than the KVI-6314 amphiphilic terpolymer. The KVI-6224 amphiphilic terpolymer performed slightly worse as a dehydrating agent, reaching a maximum efficiency of 73 vol % at 90 minutes, followed by the KVI-8114 and KVI-7124 amphiphilic terpolymers, which removed 67 vol % at 180 and 300 minutes into the evaluation, respectively. Finally, the KVI-9554 and KVI-6134 amphiphilic terpolymers only removed 53 vol % at 90 and 180 minutes of test, respectively.

Regarding the other evaluated dehydrating agents, the commercial formulations FD-1 and FD-3, as well as the ionic liquid TOMAC, removed 53 vol % at 240 minutes and 300 minutes (for the latter two demulsifiers). The difference between TOMAC and FD-3 lies in the coalescence rate exhibited during the experiment, with the TOMAC ionic liquid outperforming the phenolic resin-based formulation (FD-3). Finally, the FD-2 and FD-4 formulations barely removed 40 vol % of the emulsified water.

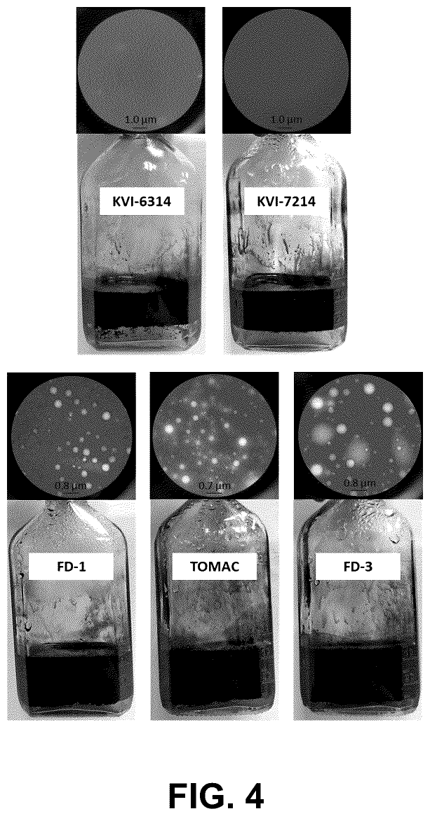

FIG. 4 shows the optical micrographs of the crude oil treated with the KVI-6314 amphiphilic terpolymer (100 vol %, 180 min) and KVI-7214 (100 vol %, 240 min), where the absence of emulsified water droplets is evident (total removal). In contrast, the micrographs of crude oil treated with FD-1 (53 vol %, 240 min), TOMAC (53 vol %, 300 min), with a higher rate than the FD-3 product (phenolic resin-based formulation)) and FD-3 (53 vol %, 300 min) show polydisperse dispersion of emulsified water, where the diameter of the emulsified water droplets was approximately 0.3 μm for the crude oil treated with FD-1; whereas for the crude oil treated with TOMAC and FD-3, it was 0.5 μm and 0.6 μm, respectively.

Regarding the clarification of the removed water, the amphiphilic terpolymers KVI-6314 and KVI-7214 exhibited excellent performance in clarifying the withdrawn water. In contrast, commercial formulations and ionic liquids demonstrated lower water clarification performance.

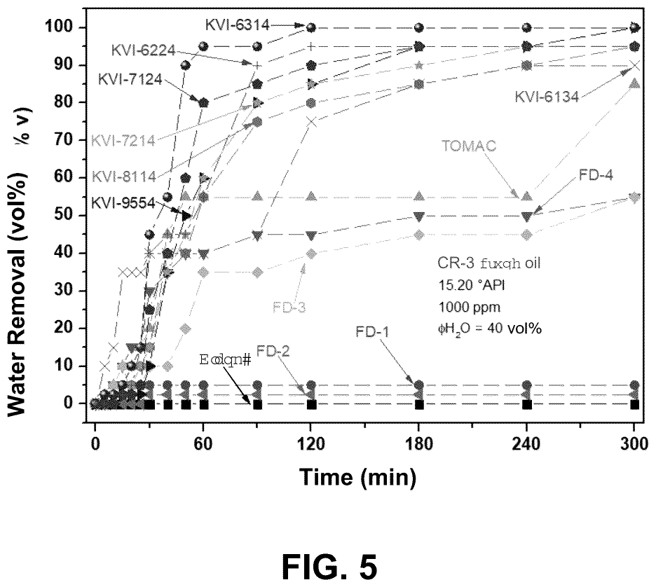

FIG. 5 shows the performance of the KVI amphiphilic terpolymers with random sequences of alkyl acrylate-vinyl-aminoalkyl acrylate in Lacanhá-3 crude oil (15.60° API, Ø_{H}_{₂}_{O}=40 vol %), dosed at 1000 ppm. The KVI-6314 and KVI-6224 amphiphilic terpolymers achieved 100% removal of emulsified water at 120 minutes and 300 minutes, respectively, with the superior performance of the KVI-6314 amphiphilic terpolymer in inducing the coalescence of emulsified water droplets being evident. Regarding the KVI-9554, KVI-8114, KVI-7214, and KVI-7124 amphiphilic terpolymers, they showed good performance in destabilizing the water/crude oil interface, eliminating 95 vol % of the emulsified water at different evaluation times: 300 minutes for KVI-9554, 180 minutes for KVI-8114, 240 minutes for KVI-7214, and 180 minutes for KVI-7124. Although the KVI-6134 amphiphilic terpolymer showed lower performance compared to the previously mentioned terpolymers, it achieved a total removal of 90 vol % at 240 minutes. On the other hand, regarding the ionic liquid and commercial products, TOMAC showed a low water removal efficiency (f 55 vol %) at 240 minutes; however, it managed to remove 85 vol % by the end of the evaluation. In this sense, TOMAC has a lower capacity to destabilize the water/crude oil interface and, therefore, to promote the coalescence of water droplets compared to the performance of the amphiphilic terpolymers of the present disclosure. The commercial formulations FD-3 and FD-4 showed low efficiency as demulsifying agents, with both removing 55 vol % at 300 minutes; however, FD-4 demonstrated greater efficiency as a coalescing agent than FD-3 during the evaluation until the 240-minute mark. Finally, the commercial formulations FD-1 and FD-2 barely managed to remove 5 vol % and 2.5 vol % of the emulsified water, making their low capacity to destabilize the layer of asphaltenes and resins surrounding the water droplets unquestionable.

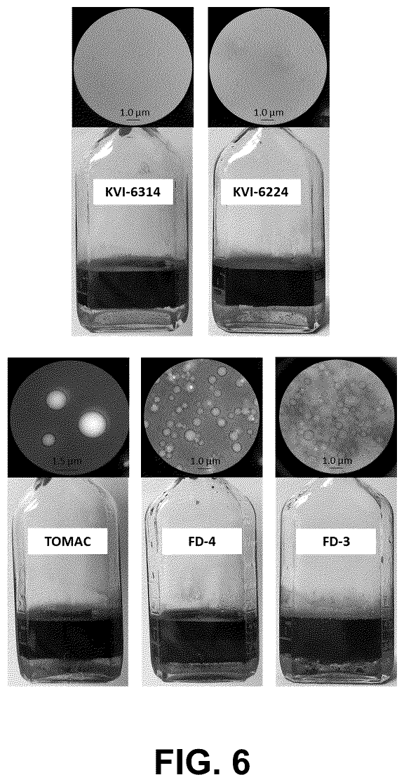

FIG. 6 shows the optical micrographs of the crude oil treated with the KVI-6314 amphiphilic terpolymer (100 vol %, 120 min) and KVI-6224 (100 vol %, 300 min), where no presence of emulsified water droplets is observed, thus demonstrating the excellent performance of these amphiphilic terpolymers as dehydrating agents. In the micrograph of the crude oil treated with the TOMAC ionic liquid (85 vol %, 300 min), a polydisperse dispersion of water droplets with diameters ranging from 0.75 to 1.50 μm is observed. In the case of the commercial formulations FD-4 and FD-3—, both 55 vol %, but with different coalescing efficiencies during the test—, both optical micrographs show a polydisperse system of emulsified water with droplet sizes ranging from 0.10 to 0.60 μm.

Regarding the clarification of the removed water, the amphiphilic terpolymers KVI-6314 and KVI-7214 demonstrated excellent performance in clarifying the withdrawn water. In contrast, the TOMAC and the commercial formulations exhibited lower performance in water clarification.

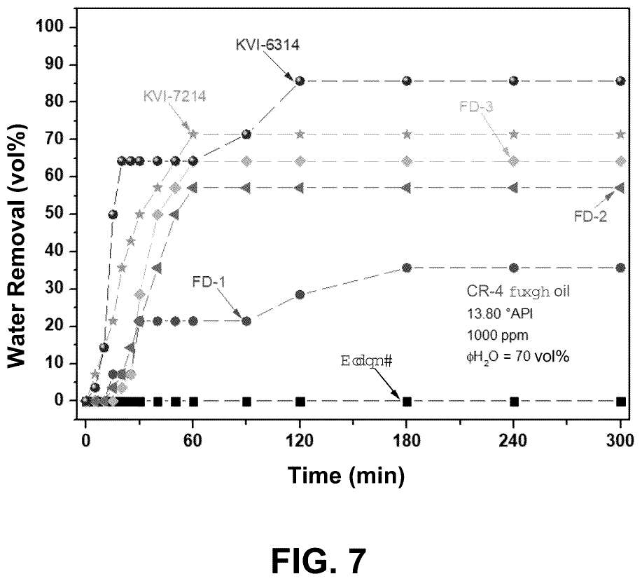

FIG. 7 shows the performance of the amphiphilic terpolymers KVI-6314 and KVI-7214, as well as the commercial formulations FD-1, FD-2, and FD-3 in Lacanhá-4 crude oil (13.80° API, Ø_{H}_{₂}_{O}=70 vol %), dosed at 1000 ppm. Both amphiphilic terpolymers achieved better performance in the removal of emulsified water, compared to the commercial products, removing 86 vol % (KVI-6314 at 120 minutes) and 71 vol % (KVI-7214 at 60 minutes). The commercial formulation FD-3—based on phenolic ethoxylated resin—removed 64 vol % of water at 60 minutes, while the FD-2—based on nonyl phenol ethoxylated—and FD-1—based on triblock copolymer PPO/PEO—formulations removed 57 vol % (60 minutes) and 36 vol % (180 minutes), respectively.

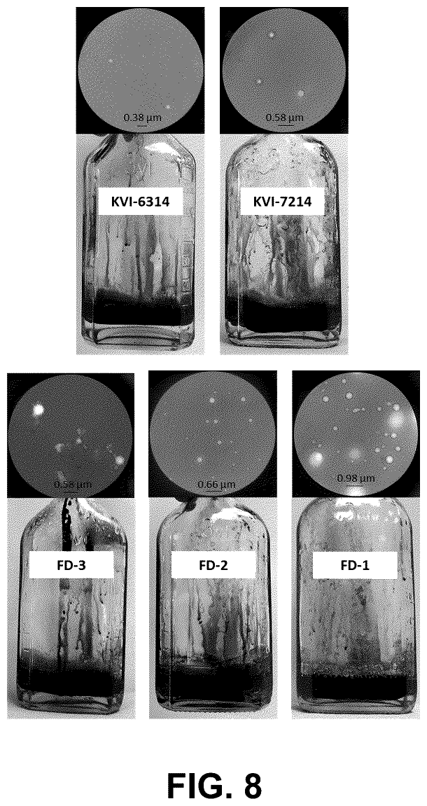

FIG. 8 presents the optical micrographs of the crude oil treated with the amphiphilic terpolymers KVI-6314 (86 vol %, 120 min)—and KVI-7214 (71 vol %, 60 min). In the first micrograph—treatment with KVI-6314—droplets of emulsified water with a diameter of approximately 0.19 μm are observed, while in the second micrograph (treatment with KVI-7214) the diameter of the water droplets ranges from 0.15 to 0.29 μm.

Regarding the commercial formulations, the micrograph of the crude oil treated with FD-3 shows a low polydispersity system, with water droplets having diameters between 0.30 and 0.40 μm, while the oil treated with FD-2 shows a polydisperse system, with droplet sizes ranging from 0.07 to 0.30 μm. Finally, the treatment with FD-1 results in a highly polydisperse system, with water droplets having diameters ranging from 0.09 to 0.98 μm, highlighting its deficient performance in inducing the coalescence of water droplets.

In conclusion, the amphiphilic terpolymers KVI-6314 and KVI-7214 exhibited superior performance in the clarification of removed water, markedly surpassing the performance of the commercial formulations FD-1, FD-2, and FD-3.

What is claimed is:

1. Amphiphilic terpolymers with random alkyl acrylic-vinyl-aminoalkyl acrylic sequences, as dehydrating agents for the removal of emulsified water in crude oil with gravities of 10 to 40° API, with different water content and SARA components, where the terpolymer is characterized with the structural formula (1) with molecular masses between 1,000 and 700,000 g·mol⁻¹, where formula (1) is as follows: 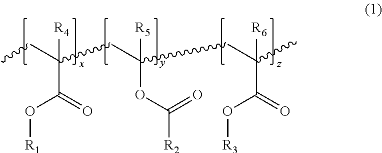
where:
R₁═CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₆H₁₁ (di(ethylene glycol))ethyl ether), C₈H₁₇ (2-ethylhexyl), C₉H₁₉ (3,5,5-trimethylhexyl), C₈H₁₇ (n-octyl), C₈H₁₇ (iso-octyl), C₈H₉ (ethylene glycol phenyl ether), C₁₀H₂₁ (n-decyl), C₁₀H₂₁ (iso-decyl), C₁₀H₁₉ (10-undecenyl), C₁₀H₁₉ (tert-butylcyclohexyl), C₁₂H₂₅ (n-dodecyl), C₁₈H₃₇ (n-octadecyl), C₈H₉O (2-phenoxyethyl), C₃H₇O (2-methoxyethyl), C₅H₁₁O₂ (2-(2-methoxyethoxy)ethyl), C₅H₉O (tetrahydrofurfuryl), C₅H₉₀ (2-tetrahydropyranyl), C₁₃H₂₇ (n-tridecyl), C₂₂H₄₅ (behenyl), it is important to highlight that the chain of these groups can present various heteroatoms, as well as aromatic rings with or without heteroatoms;
R₂═CH₃, Ph, C₂H₅, C₅H₇, C₁₁H₂₃, C₁₇H₃₃;
R₃═CH₄N (methylamine), C₃H₆N (2-ethylamine), C₃H₈N (3-propylamine), C₄H₁₀N (2-(dimethylamino)ethyl), C₅H₁₂N (3-(dimethylamino)propyl), C₆H₁₄N (2-(diethylamino)ethyl) or C₆H₁₄NO (N-morpholinyl ethyl). Aliphatic chains may contain from 1 to 25 carbon atoms;
R₄ and R₆═H (hydrogen) or CH₃ (methyl);
R₅═H (hydrogen), CH₃ o CN;
where:
x=It is a number ranging from 2 to 900;
y=It is a number ranging from 2 to 900;
z=It is a number ranging from 2 to 900; and
where “x”, “y” and “z” are present as random sequences.

2. The amphiphilic terpolymers according to claim 1, wherein the ratio of the alkyl acrylic monomer is between 99.40 and 55.00 wt. %, the vinyl monomer is in a compositional range between 0.30 and 44.70 wt. %, and the aminoalkyl acrylic monomer is in a range between 0.30 and 44.70 wt. %.

3. The amphiphilic terpolymers according to claim 2, wherein the alkyl acrylic monomer is selected from the group consisting of methyl acrylate, methyl methacrylate, ethyl acrylate, ethyl methacrylate, n-butyl acrylate, n-butyl methacrylate, iso-butyl acrylate, iso-butyl methacrylate, tert-butyl acrylate, tert-butyl methacrylate, pentyl acrylate, pentyl methacrylate, hexyl acrylate, hexyl methacrylate, (di(ethylene glycol)ethyl ether acrylate), (di(ethylene glycol)ethylether methacrylate), 2-ethylhexyl acrylate, 2-ethylhexyl methacrylate, 2-ethylhexyl, (3,5,5-trimethylhexyl acrylate), (3,5,5-trimethylhexyl methacrylate), n-octyl acrylate, n-octyl methacrylate, iso-octyl acrylate, iso-octyl methacrylate, (ethyleneglycol phenylether) acrylate, (ethyleneglycol phenylether) methacrylate, n-decyl acrylate, n-decyl methacrylate, iso-decyl acrylate, iso-decyl methacrylate, undecenyl acrylate, undecenyl methacrylate, tert-butylcyclohexyl acrylate, tert-butylcyclohexyl methacrylate, n-dodecyl acrylate, n-dodecyl methacrylate, n-octadecyl acrylate, n-octadecyl methacrylate, 2-phenoxyethyl acrylate, 2-phenoxyethyl methacrylate, 2-(2-methoxyethoxy)ethyl acrylate, 2-(2-methoxyethoxy)ethyl methacrylate, tetrahydrofurfuryl acrylate, tetrahydrofurfuryl methacrylate, (2-tetrahydropyranyl) acrylate, (2-tetrahydropyranyl) methacrylate, n-tridecyl acrylate, n-tridecyl methacrylate, behenyl acrylate, and behenyl methacrylate.

4. The amphiphilic terpolymers according to claim 3, wherein the vinyl monomer is selected from the group consisting of cyanoethylene acetate, vinyl propionate, vinyl benzoate, vinyl butyrate, vinyl laurate, and vinyl stearate.

5. The amphiphilic terpolymers according to claim 4, wherein the aminoalkyl acrylic monomer is selected from the group consisting of 2-aminoethyl acrylate, 2-aminoethyl methacrylate, 2-(dimethylamino)ethyl acrylate, 2-(dimethylamino)ethyl methacrylate, 3-aminopropyl acrylate, 3-aminopropyl methacrylate, 3-(dimethylamino)propyl acrylate, 3-(dimethylamino)propyl methacrylate, 2-(dimethylamino)ethyl acrylate, 2-diethylamino)ethyl methacrylate, 2-N-ethylmorpholine acrylate, and N-ethylmorpholine methacrylate.

6. A method comprising:
using amphiphilic terpolymers with random alkyl acrylic-vinyl-aminoalkyl acrylic sequences, as dehydrating agents for the removal of emulsified water in crude oil with gravities of 10 to 40° API, with different water content and SARA components, where the terpolymer is characterized with the structural formula (1) with molecular masses between 1,000 and 700,000 g·mol⁻¹, where formula (1) is as follows: 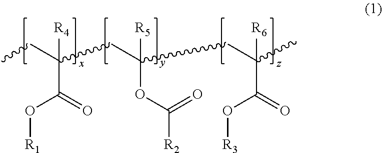
where:
R₁═CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₆H₁₁ (di(ethylene glycol))ethyl ether), C₈H₁₇ (2-ethylhexyl), C₉H₁₉ (3,5,5-trimethylhexyl), C₈H₁₇ (n-octyl), C₈H₁₇ (iso-octyl), C₈H₉ (ethylene glycol phenyl ether), C₁₀H₂₁ (n-decyl), C₁₀H₂₁ (iso-decyl), C₁₀H₁₉ (10-undecenyl), C₁₀H₁₉ (tert-butylcyclohexyl), C₁₂H₂₅ (n-dodecyl), C₁₈H₃₇ (n-octadecyl), C₈H₉O (2-phenoxyethyl), C₃H₇O (2-methoxyethyl), C₅H₁₁O₂ (2-(2-methoxyethoxy)ethyl), C₅H₉O (tetrahydrofurfuryl), C₅H₉O (2-tetrahydropyranyl), C₁₃H₂₇ (n-tridecyl), C₂₂H₄₅ (behenyl), it is important to highlight that the chain of these groups can present various heteroatoms, as well as aromatic rings with or without heteroatoms;
R₂═CH₃, Ph, C₂H₅, C₅H₇, C₁₁H₂₃, C₁₇H₃₃;
R₃═CH₄N (methylamine), C₃H₆N (2-ethylamine), C₃H₈N (3-propylamine), C₄H₁₀N (2-(dimethylamino)ethyl), C₅H₁₂N (3-(dimethylamino)propyl), C₆H₁₄N (2-(diethylamino)ethyl) or C₆H₁₄NO (N-morpholinyl ethyl). Aliphatic chains may contain from 1 to 25 carbon atoms;
R₄ and R₆═H (hydrogen) or CH₃ (methyl);
R₅═H (hydrogen), CH₃ o CN;
where:
x=It is a number ranging from 2 to 900;
y=It is a number ranging from 2 to 900;
z=It is a number ranging from 2 to 900; and
where “x”, “y” and “z” are present as random sequences.

7. The method according to claim 6, wherein the concentration of dry terpolymers in a formulation of the terpolymers with a solvent is between 0.50 and 50.00 wt. %.

8. The method according to claim 6, wherein the ratio of the alkyl acrylic monomer is between 99.40 and 55.00 wt. %, the vinyl monomer is in a compositional range between 0.30 and 44.70 wt. %, and the aminoalkyl acrylic monomer is in a range between 0.30 and 44.70 wt. %.

9. The method according to claim 8, wherein the alkyl acrylic monomer is selected from the group consisting of methyl acrylate, methyl methacrylate, ethyl acrylate, ethyl methacrylate, n-butyl acrylate, n-butyl methacrylate, iso-butyl acrylate, iso-butyl methacrylate, tert-butyl acrylate, tert-butyl methacrylate, pentyl acrylate, pentyl methacrylate, hexyl acrylate, hexyl methacrylate, (di(ethyleneglycol)ethyl ether acrylate), (di(ethyleneglycol)ethylether methacrylate), 2-ethylhexyl acrylate, 2-ethylhexyl methacrylate, 2-ethylhexyl, (3,5,5-trimethylhexyl acrylate), (3,5,5-trimethylhexyl methacrylate), n-octyl acrylate, n-octyl methacrylate, iso-octyl acrylate, iso-octyl methacrylate, (ethyleneglycol phenylether) acrylate, (ethyleneglycol phenylether) methacrylate, n-decyl acrylate, n-decyl methacrylate, iso-decyl acrylate, iso-decyl methacrylate, undecenyl acrylate, undecenyl methacrylate, tert-butylcyclohexyl acrylate, tert-butylcyclohexyl methacrylate, n-dodecyl acrylate, n-dodecyl methacrylate, n-octadecyl acrylate, n-octadecyl methacrylate, 2-phenoxyethyl acrylate, 2-phenoxyethyl methacrylate, 2-(2-methoxyethoxy)ethyl acrylate, 2-(2-methoxyethoxy)ethyl methacrylate, tetrahydrofurfuryl acrylate, tetrahydrofurfuryl methacrylate, (2-tetrahydropyranyl) acrylate, (2-tetrahydropyranyl) methacrylate, n-tridecyl acrylate, n-tridecyl methacrylate, behenyl acrylate, and behenyl methacrylate.

10. The method according to claim 9, wherein the vinyl monomer is selected from the group consisting of cyanoethylene acetate, vinyl propionate, vinyl benzoate, vinyl butyrate, vinyl laurate, and vinyl stearate.

11. The method according to claim 10, wherein the aminoalkyl acrylic monomer is selected from the group consisting of 2-aminoethyl acrylate, 2-aminoethyl methacrylate, 2-(dimethylamino)ethyl acrylate, 2-(dimethylamino)ethyl methacrylate, 3-aminopropyl acrylate, 3-aminopropyl methacrylate, 3-(dimethylamino)propyl acrylate, 3-(dimethylamino)propyl methacrylate, 2-(dimethylamino)ethyl acrylate, 2-diethylamino)ethyl methacrylate, 2-N-ethylmorpholine acrylate, and N-ethylmorpholine methacrylate.

12. A formulation of amphiphilic terpolymers with random alkyl acrylic-vinyl-aminoalkyl acrylic sequences, as dehydrating agents for crude oil, wherein dry random amphiphilic terpolymers are dissolved in solvents selected from the group consisting of dichloromethane, methanol, ethanol, isopropanol, chloroform, dimethyl sulfoxide, tetrahydrofuran, dioxane, 2-butoxyethanol, 2-butoxyethanol acetate, toluene, xylene, jet fuel, and naphtha,
wherein the terpolymer is characterized with the structural formula (1) with molecular masses between 1,000 and 700,000 g·mol⁻¹, where formula (1) is as follows: 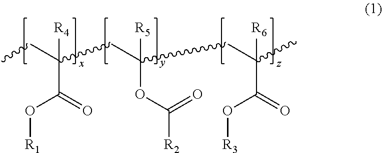
where:
R₁═CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₆H₁₁ (di(ethylene glycol))ethyl ether), C₈H₁₇ (2-ethylhexyl), C₉H₁₉ (3,5,5-trimethylhexyl), C₈H₁₇ (n-octyl), C₈H₁₇ (iso-octyl), C₈H₉ (ethylene glycol phenyl ether), C₁₀H₂₁ (n-decyl), C₁₀H₂₁ (iso-decyl), C₁₀H₁₉ (10-undecenyl), C₁₀H₁₉ (tert-butylcyclohexyl), C₁₂H₂₅ (n-dodecyl), C₁₈H₃₇ (n-octadecyl), C₈H₉O (2-phenoxyethyl), C₃H₇O (2-methoxyethyl), C₅H₁₁O₂ (2-(2-methoxyethoxy)ethyl), C₅H₉O (tetrahydrofurfuryl), C₅H₉O (2-tetrahydropyranyl), C₁₃H₂₇ (n-tridecyl), C₂₂H₄₅ (behenyl), it is important to highlight that the chain of these groups can present various heteroatoms, as well as aromatic rings with or without heteroatoms;
R₂═CH₃, Ph, C₂H₅, C₅H₇, C₁₁H₂₃, C₁₇H₃₃;
R₃═CH₄N (methylamine), C₃H₆N (2-ethylamine), C₃H₈N (3-propylamine), C₄H₁₀N (2-(dimethylamino)ethyl), C₅H₁₂N (3-(dimethylamino)propyl), C₆H₁₄N (2-(diethylamino)ethyl) or C₆H₁₄NO (N-morpholinyl ethyl). Aliphatic chains may contain from 1 to 25 carbon atoms;
R₄ and R₆═H (hydrogen) or CH₃ (methyl);
R₅═H (hydrogen), CH₃ o CN;
where:
x=It is a number ranging from 2 to 900;
y=It is a number ranging from 2 to 900;
z=It is a number ranging from 2 to 900; and
where “x”, “y” and “z” are present as random sequences.

13. A method comprising:
using formulations according to claim 12 as demulsifying agents for crude oils, wherein the formulations of the terpolymer dissolved in a solvent are dosed in the crude oil at a concentration in a range between 10 and 3,000 ppm.
